(19) United States
(12) Patent Application Publication
(10) Pub. No.: US 2004/0247990 A1
(43) Pub. Date: Dec. 9, 2004

(54) Platinum alloy catalysts for electrochemical fuel cells

(76) Inventor: Stephen A. Campbell, Maple Ridge (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/802,406

(22) Filed: Mar. 17, 2004

Related U.S. Application Data
(60) Provisional application No. 60/456,250, filed on Mar. 19, 2003.
(60) Provisional application No. 60/467,653, filed on May 1, 2003.

(51) Int. Cl. H01M 4/92; H01M 4/94; H01M 8/10

(52) U.S. Cl. 429/44; 429/30

(57) ABSTRACT

Operation of an electrochemical fuel cell may lead to formation of oxide and/or hydroxide layers forming on the surface of a platinum catalyst on the cathode electrode which may, in turn, lead to reduced fuel cell performance. Such formation oxides and hydroxides may be inhibited or even eliminated by alloying the platinum catalyst with less than 10% of a noble metal selected from rhodium, iridium, palladium and gold or a combination thereof.

### CROSS-REFERENCE TO RELATED APPLICATIONS

This application relates to and claims priority benefits from U.S. Provisional Patent Application No. 60/456,250 filed Mar. 19, 2003 and U.S. Provisional Patent Application No. 60/467,653 filed May 1, 2003, which provisional applications are incorporated herein by reference in their entireties.

### BACKGROUND OF THE INVENTION

1. Field of the Invention

This invention relates to catalysts for electrochemical fuel cells and more particularly to the use of platinum alloys as cathode catalysts for the oxygen reduction reaction in electrochemical fuel cells.

2. Description of the Related Art

Fuel cell systems are increasingly being used as power supplies in various applications, such as stationary power plants and portable power units. Such systems offer the promise of economically delivering power while providing environmental benefits.

Fuel cells convert fuel and oxidant reactants to generate electric power and reaction products. They generally employ an electrolyte disposed between cathode and anode electrodes. A catalyst typically induces the desired electrochemical reactions at the electrodes. Preferred fuel cell types include polymer electrolyte membrane (PEM) fuel cells that comprise an ion-exchange membrane as electrolyte and operate at relatively low temperatures.

PEM fuel cells employ a membrane electrode assembly (MEA) that comprises the ion-exchange membrane disposed between the cathode and anode. Each electrode contains a catalyst layer, comprising an appropriate catalyst, located next to the ion-exchange membrane. The catalyst is typically a precious metal composition (e.g., platinum metal black or an alloy thereof) and may be provided on a suitable support (e.g., fine platinum particles supported on a carbon black support). The catalyst layers may also contain ionomer. In particular, an improved interface between the catalyst layer and the ion-exchange membrane may be observed if the ionomer in the catalyst layer is similar to that in the ion-exchange membrane (e.g., where both are Nafion®). The electrodes may also contain a porous, electrically conductive substrate that may be employed for purposes of mechanical support, electrical conduction, and/or reactant distribution, thus serving as a fluid diffusion layer. Flow field for directing the reactants across one surface of each electrode or electrode substrate, are disposed on each side of the MEA. In operation, the output voltage of an individual fuel cell under load is generally below one volt. Therefore, in order to provide greater output voltage, numerous cells are usually stacked together and are connected in series to create a higher voltage fuel cell stack.

During normal operation of a PEM fuel cell, fuel is electrochemically oxidized at the anode catalyst, typically resulting in the generation of protons, electrons, and possibly other species depending on the fuel employed. The protons are conducted from the reaction sites at which they are generated, through the ion-exchange membrane, to electrochemically react with the oxidant at the cathode exhaust. The electrons travel through an external circuit providing useable power and then react with the protons and oxidant at the cathode catalyst to generate water reaction product.

A broad range of reactants can be used in PEM fuel cells and may be supplied in either gaseous or liquid form. For example, the oxidant stream may be substantially pure oxygen gas or a dilute oxygen stream such as air. The fuel may be, for example, substantially pure hydrogen gas, a gaseous hydrogen-containing reformate stream, or an aqueous liquid methanol mixture in a direct methanol fuel cell.

For various reasons, fuel cell performance can fade with operation of time or as a result of storage. However, some of these performance losses may be reversible. For instance, the negative effect of the ion-exchange membrane and/or other ionomer drying out during storage can be reversed by rehydrating the fuel cell. Also, the negative effects of CO contamination of an anode catalyst can be reversed using electrical and/or fuel starvation techniques. U.S. Pat. Nos. 6,096,448; 6,329,089 and 6,472,090 disclose some of the other various advantages and/or performance improvements that can be obtained using appropriate starvation techniques in fuel cells.

While some of the mechanisms affecting performance in fuel cells are understood and means have been developed to mitigate them, other mechanisms affecting performance are not yet fully understood and unexpected effects on performance are just being discovered.

### BRIEF SUMMARY OF THE INVENTION

Platinum catalysts are typically used within the PEM fuel cell environment. On assembly or after a period of prolonged storage, lower than nominal performance may be seen. A possible cause of such reduced performance may be the formation of oxides and/or hydroxides on the cathode catalyst surface, and in particular, the formation of a relatively thick layer of such oxides or hydroxides on the cathode catalyst surface.

To inhibit the formation of such a relatively thick oxide layer on the cathode platinum catalyst surface, an alloy of platinum with a second metal may be used instead of pure platinum. For example, an alloy of platinum with at least one of gold, rhodium, iridium and palladium may be used. Further, only a relatively small amount of the second metal needs to be present, for example less than 10% and more particularly, less than 5%, or less than 3% and even more particularly less than 1% as compared to the amount of platinum present. The presence of the second noble metal, though not necessarily aiding in the oxygen reduction reaction, may inhibit the formation of oxide layers.

In particular, in an embodiment, a membrane electrode assembly for an electrochemical fuel cell comprises:

an anode fluid diffusion layer and a cathode fluid diffusion layer;

an ion-exchange membrane interposed between the anode and cathode fluid diffusion layers;

an anode catalyst layer interposed between the anode fluid diffusion layer and the ion-exchange membrane; and

a cathode catalyst layer interposed between the cathode fluid diffusion layer and the ion-exchange membrane.

The cathode catalyst layer comprises a platinum catalyst alloyed with less than 10% of a noble metal selected from rhodium, iridium, palladium and gold. A combination of rhodium, iridium, palladium and gold could be used though in a binary catalyst, the platinum is alloyed with only one of the above noble metals. The membrane electrode assembly may also be incorporated into a fuel cell, or a fuel cell stack with at least one such fuel cell.

The fuel cell performance of an individual fuel cell may thus be improved as well as the performance of a fuel cell stack comprising at least one of such fuel cells. While shorting and/or starvation techniques may also be employed to remove oxides and/or hydroxides from the platinum surface, the need for such techniques is likely reduced with fuel cells containing the present platinum alloy catalysts.

These and other aspects of the invention will be evident upon reference to the attached figure and following detailed description.

### BRIEF DESCRIPTION OF THE DRAWINGS

FIG. 1 is a cyclic voltammogram of an ex-situ cathode sample after 2 treatments.

### DETAILED DESCRIPTION OF THE INVENTION

Without being bound by theory, it is believed that lower than nominal performance capability seen in newly manufactured PEM fuel cells or in cells subjected to prolonged storage may be due to the formation of oxides or hydroxides on the surface of the cathode catalyst. Such species could be expected to form in the presence of oxygen and water and the rate would increase at elevated temperatures.

Platinum surface chemistry has been well-characterized and in particular the place-exchange process is discussed in Yang, Y.-F. and Denault, G.; J. Electroanal. Chem. 443 (1998) 273-282 at 274. The place-exchange process is a reorganization of the HOPt layer at higher potentials. The overall oxidation process is thought to occur according to:

4Pt+H₂O→Pt₄OH+H⁺+e⁻ (1)

Pt₄OH+H₂O→2Pt₂OH+H⁺+e⁻ (2)

Pt₂OH+H₂O→2PtOH+H⁺+e⁻ (3)

PtOH→HOPt (4)

HOPt→OPt+H⁺+e⁻ (5)

Reactions in equations 1-3 are consecutive steps of Pt lattice occupation and the reaction in equation 4 is the place-exchange mechanism.

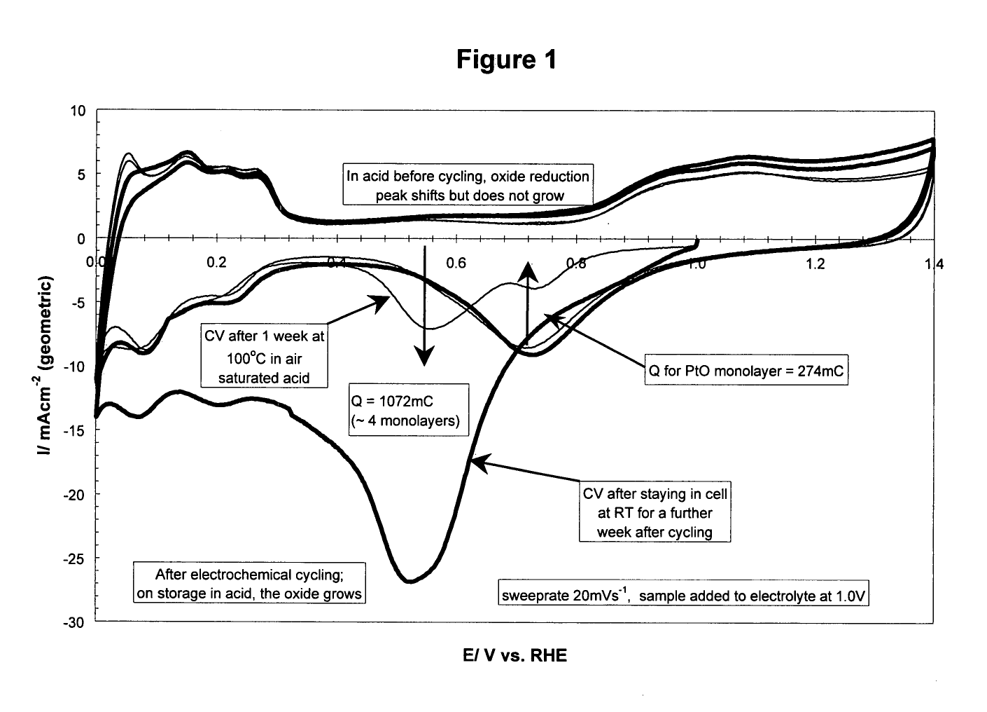

This mechanism is supported by experimental studies as illustrated in FIG. 1, which shows a cyclic voltammogram (CV) of an ex-situ cathode sample. The thin line is a CV of an ex-situ cathode sample that was refluxed for 1 week in air saturated 0.5M H₂SO₄ before being introduced to the electrolyte at 1.0V vs. RHE. Starting from 1.0V and sweeping negative, the oxide reduction peak normally seen at 0.72V is reduced and a second reduction peak at 0.57V has grown to replace it. The second more stable peak likely represents the more stable platinum oxide resulting from the place-exchange mechanism as in equation 4 above. The second cycle restores the expected response. The charge involved in both reductions are similar indicating that although there appears to be a stabilization of the oxide, the oxide does not grow beyond a single monolayer of oxygen. The thick line in FIG. 1 is a cyclic voltammogram of the same cathode sample after exposure to ambient air, while remaining in the cell for a further week. Prior to removal from the solution, nitrogen was bubbled to remove air and a CV was performed. As shown in FIG. 1, it can be seen that the more stable oxide appears to have grown to about four times the thickness (i.e., approx. 4 monolayers) and complete reduction is slow. On reduction and subsequent cycling, the normal multicycled Pt response is restored.

The thick oxide has been shown to be relatively stable to reduction as compared to the monolayer or submonolayer as typically found on the platinum catalyst surface during fuel cell operation (see for example Burke. L. D. and Buckley, D. T.; J. Electroanal. Chem. 405 (1996) 101-109). Ex situ results thus show that a thicker oxide layer forms over time on the cathode layer thereby leading to reduced fuel cell performance, particularly when stored after initial cycling. The place-exchange process as discussed above allows for the formation of a thicker oxide layer on the platinum surface that may inhibit fuel cell performance.

Methods to assist in the removal of surface oxides and/or hydroxides from the cathode catalyst or to prevent their formation are desirably contemplated. For instance, oxidant starving techniques may be employed to assist in their removal. Also, for instance, the fuel cell might be maintained in a conditioned state in various ways in order to prevent temporary losses in performance capability. As an example, storing the fuel cell at below ambient temperature would slow the rate of formation of oxides or hydroxides. Blanketing the cathode with an inert gas such as dry nitrogen during storage would also be expected to slow the formation of oxide/hydroxide species. In this regard, a reducing atmosphere could also be used to blanket the cathode.

A reducing atmosphere can be readily accomplished by maintaining a hydrogen pressure on the anode during shutdown/storage with no oxygen present at the cathode. For example, the fuel supply could be left open with the exhaust being closed whereas the oxidant supply could be closed. The remaining oxidant may then be consumed by hydrogen diffusing across the membrane or reacted away quickly by putting a load across the cell. In this state, hydrogen would eventually diffuse across the membrane thereby blanketing both the anode and the cathode and preventing the formation of oxides on both. A faster warm up time and greater power output may thus be observed on startup.

An alternative, preventative measure to reduce or eliminate the formation of oxides and/or hydroxides on the surface of the cathode catalyst is to alter the surface electrochemistry on the platinum catalyst. This may be done by alloying the platinum with a second metal. Without being bound by theory, the place-exchange process occurs largely because of lattice energy considerations and would therefore occur to a greater extent on pure crystals. Any modification of the lattice by, for example, alloying a second metal with the platinum may distort these energies and thereby inhibit or even eliminate formation of oxides and/or hydroxides on the surface of the platinum catalyst.

The selection of the second metal may depend, for example, on its solubility in platinum and its stability within the cathode environment. A suitable second metal may be, for example, gold as it forms solutions relatively easily and is electrochemically unreactive with respect to cathode potentials. Other suitable second metals may include noble metals such as rhodium, iridium or palladium.

Only a relatively small amount of the second metal need be present to inhibit oxide formation. For example, less than 10%, more particularly less than 5%, less than 3% and even less than 1% of the second metal may be sufficient. There may be, for example, more than 0.1% of the second metal alloyed with the platinum catalyst. The second metal may assist with the oxygen reduction reaction or otherwise improve catalytic activity though it will more typically be electrochemically inert. Accordingly, an excess of the second metal present in the catalyst may impede fuel cell performance, as fewer platinum sites would therefore be available for oxygen reduction.

From the foregoing, it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A membrane electrode assembly for an electrochemical fuel cell comprising:
an anode fluid diffusion layer and a cathode fluid diffusion layer;
an ion-exchange membrane interposed between the anode and cathode fluid diffusion layers;
an anode catalyst layer interposed between the anode fluid diffusion layer and the ion-exchange membrane; and
a cathode catalyst layer interposed between the cathode fluid diffusion layer and the ion-exchange membrane, the cathode catalyst layer comprising a platinum catalyst alloyed with less than 10% of a noble metal selected from rhodium, iridium, palladium and gold.

2. The membrane electrode assembly of claim 1 wherein the noble metal is gold.

3. The membrane electrode assembly of claim 1 wherein the platinum is alloyed with less than 5% of the noble metal.

4. The membrane electrode assembly of claim 1 wherein the platinum is alloyed with less than 3% of the noble metal.

5. The membrane electrode assembly of claim 1 wherein the platinum is alloyed with less than 1% of the noble metal.

6. The membrane electrode assembly of claim 1 wherein the platinum catalyst is supported.

7. The membrane electrode assembly of claim 1 wherein the platinum catalyst is a binary catalyst.

8. An electrochemical fuel cell comprising the membrane electrode assembly of claim 1.

9. An electrochemical fuel cell stack comprising at least one fuel cell of claim 8.
